(19) United States
(12) Patent Application Publication
(10) Pub. No.: US 2008/0094818 A1
(43) Pub. Date: Apr. 24, 2008

(54) Solar street lights

(76) Inventor: Patricia Edwards Harris, (US)

Correspondence Address: Patricia Edwards Harris, 17334 Hartwell St., Detroit, MI, 48235, US

(21) Appl. No.: 11/523,540

(22) Filed: Oct. 20, 2006

(51) Int. Cl. F21L 4/00; F21V 25/00

(52) U.S. Cl. 362/20; 362/183

(57) ABSTRACT

This Solar Street Light would be available as an innovative lighting method.

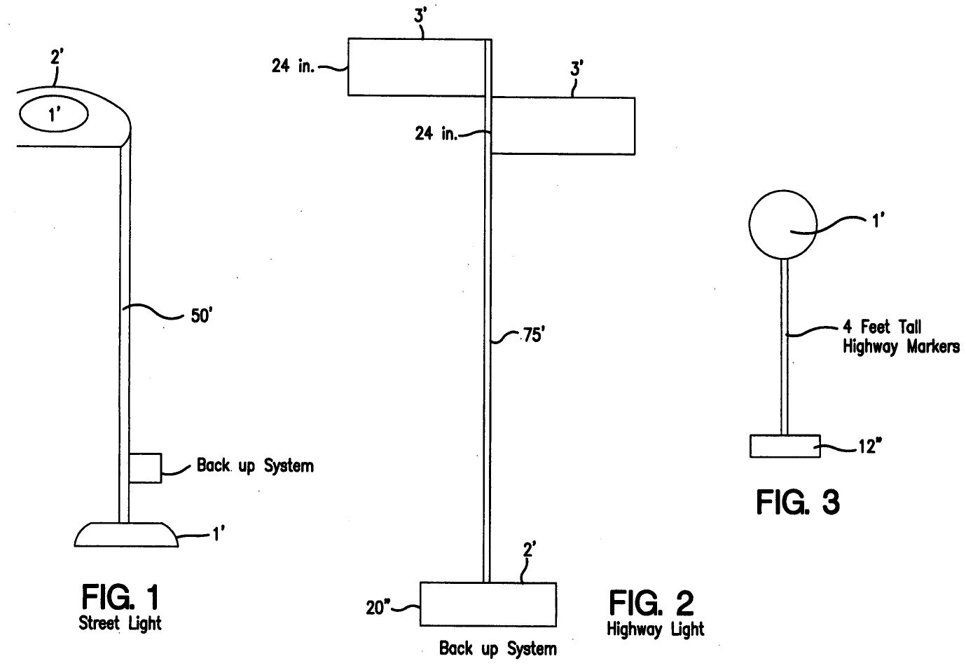

They would be positioned approximately 75 feet high a Pole above the streets, and A 50 feet high Pole over the highways.

This Solar Street Lights could provide some sense of peace of mind in knowing that there is an effective device available to provide light in areas where there is no light, with less taxpaying dollars.

This Solar Street Lights has the potential to become an important ingredient in this recipe of energy usage technology.

This Solar Street Light would have Two large Boxes one an each side of the pole far visual seeing, using the largest Battery Pack known plus an electrical Backup.

This Solar Street Light would be a great safety device, for Street where animals are and for areas where people walk or ride there bikes or for automobiles that have stopped along the highways.

This Solar Street Light will house more light for world safety everywhere.

There are a number of reasons why this innovative idea can be beneficial. Street lighting is a vital element in many urban and suburban areas across the United States. These lights are used to line sidewalks in heavily populated areas in major cities. They brighten up roadways to enable drivers to preserve their vision and maintain awareness of other drivers and driving routes. Many people enjoy the services of streetlights when walking toward intersections where beacon lights provide contrast against darkness. A new invention idea may be able to assist individuals in staying safer in their neighborhoods or on the roads. Solar Street Lights could save money and resources used to sustain current high-energy demands. It uses a specially designed 50V battery to store solar energy for light and has an option for using an electrical back up system. Solar Street Lights would be tools to help communities to see in areas where streetlights are not available. Motorists would be able to spot animals crossing roads to prevent road kill and pedestrians waiting at bus stops can have lighting to illuminate isolated areas. Considering these facts, it seems logical to champion a product with as many potential benefits as Solar Street Lights.

In the words of Inventor Patricia C. Edwards, “Solar Street Lights can save money state wide and make our streets and neighborhoods safe. I believe they are more effective than products currently available.”

The elements of Solar Street Lights could be made of standard industry supply such as plastic, light metal, and electronics.

After successful development, and as word of mouth spreads and its advantages become recognized over a period of time and use, Solar Street Lights is likely to obtain a healthy percentage of the lighting installations market. It could be marketed widely through outlets such as Toyolite Technologies Corporation, Kaiphone Communications Company, Hormon Company, Elumina Technology, and Ayers Rock Enterprise Corporation as well as through Internet channels such as Lanecontrols.com, Talklight.com, and many others.

Demographics for this product are fairly wide. Solar Street Lights can position itself in the large lighting installations market.

Experts are exuding a growing confidence in the American economy, which is good news for innovation in general and Solar Street Lights in particular. According to Mortimer B. Zuckerman, Editor-in-Chief of U.S. News and World Report, “We are on a trajectory toward extraordinary growth in the first half of 2005 that will beget stronger job and income growth, stronger retail spending, and accelerating demand at a time when businesses have cut costs, raising profit margins to their highest levels in years.”

Mr. Zuckerman is not the only optimistic voice out there. There are also those predicting good news on the job creation front, which is likely to increase discretionary spending. Said Jeffrey A. Joerres, Chairman & CEO of Manpower, Inc., “Those looking for a job are likely to find strong prospects across the majority of industry sectors surveyed, including construction, durable and non-durable goods, manufacturing, mining, services, and wholesale and retail trade.”

Optimism is apparent when talking with people who regularly monitor leading economic indicators, specifically the effect that tax cuts have had on the economy. “We are seeing the beginning of a great surge in job creation,” said Carl Camden, President of Kelly Services, Inc. “Propelling these gains are the accumulated effect of tax cuts.” Brian S. Wesbury, Chief Economist at Griffin, Kubik, Stephens and Thompson, Inc., agrees with Mr. Camden. “The tax cut of 2003 caused an immediate turnaround in the economy and the after-tax rewards for investment, saving and work effort were increased enough to overcome the elevated level of risk in the economy,” he said. “Rather than a wimpy recovery, we have entered a boom.”

### Product Benefits

PTI researched the benefits of the product, targeting the important questions, “What market should Patricia C. Edwards set her sights on? What benefits can a customer expect?” Before any new product's potential for widespread recognition and ease of use can be assessed, a thorough review of the existing need for the innovation must be assessed. Some of Solar Street Lights' primary benefits to customers are the following positive applications and considerations:
One, Solar Street Lights is relatively practical and easy to use.
Two, Solar Street Lights could help communities in avoiding excess energy usage.
Three, Solar Street Lights can be made out of readily available manufactured materials.
Four, Solar Street Lights would increase safety in well-lit areas.

### Manufacturing/Production Considerations

Raw Material Cost
Shipping and Handling Costs
Engineering and Design Costs
Tooling/Machinery and Equipment Costs
Labor Costs
Overhead and Profit
Loss, Warranty Reserves and Product Liability Insurance
Packaging
Direct/Indirect Cost Factors

For the purpose of this CIA report, you could assume the following costs based upon current economic conditions on a single unit for per piece cost.

### Estimated Costs

| | |
|---|---|
| Estimated Manufacturing Costs: | $ 19.99 |
| Wholesale Price: | $ 39.99 |
| Suggested Retail Price: | $ 59.99 |

### Product Modification Suggestions

Modify Solar Street Lights to include a similar lighting system for traffic lights.
Market Solar Street Lights to municipal planning teams, architects, and electric utility representatives.
Modify Solar Street Lights to perform the same function but be made from recycled and/or recyclable materials.
Market Solar Street Lights in various styles and colors to broaden consumer appeal.

1. I claim That my invention Solar Street Lights a device that would include an energy efficient to allow motorists and pedestrians to see clearly during hours of darkness.
I claim The Solar Street Lights would incorporate a solar light bulb and a battery backup capable of generating electricity when necessary.
I claim The Solar Street Lights unique concept and design could prove cost-effective in the long term.
I claim The use of energy efficient products is one of the best ways to reduce energy use and help the future outlook of the overall atmosphere.
I claim The depletion of the ozone layer, excessive smog, acid rain, and other forms of pollution are issues that society must deal with in the near future.
I claim this Solar Street Lights could help to inspire other potentially lifesaving ideas.
I claim This Solar Street Light would save on energy and cost.
I claim this Solar Street Light will help in Public areas for safety.
I claim This Solar Street Light will help drivers drive safer.
